(19) United States
(12) Patent Application Publication
(10) Pub. No.: US 2011/0205049 A1
(43) Pub. Date: Aug. 25, 2011

(54) ADAPTIVE LIGHTING SYSTEM WITH III-NITRIDE LIGHT EMITTING DEVICES

(75) Inventors: Jeffrey D. KMETEC, Palo Alto, CA (US); Frank M. STERANKA, San Jose, CA (US)

(73) Assignees: KONINKLIJKE PHILIPS ELECTRONICS N.V., Eindhoven (NL); PHILIPS LUMILEDS LIGHTING COMPANY, LLC, San Jose, CA (US)

(21) Appl. No.: 12/709,655

(22) Filed: Feb. 22, 2010

(51) Int. Cl. B60Q 1/34; G09F 9/33

(52) U.S. Cl. 340/465; 340/815.45

(57) ABSTRACT

A device includes a light source, a sensor, and a controller. The light source includes at least one light emitting device connected to a mount. The light emitting device comprises a plurality of segments with neighboring segments spaced less than 200 microns apart. In some embodiments, the plurality of segments are grown on a single growth substrate. Each segment includes a III-nitride light emitting layer disposed between an n-type region and a p-type region. The mount is configured such that at least two segments may be independently activated. The controller is coupled between the sensor and the mount. The controller is operable to receive an input from the sensor and based on the input, selectively illuminate at least one segment in the light source.

### BACKGROUND

1. Field of Invention

The present invention relates to an adaptive lighting system including at least one III-nitride light emitting device.

2. Description of Related Art

Semiconductor light-emitting devices including light emitting diodes (LEDs), resonant cavity light emitting diodes (RCLEDs), vertical cavity laser diodes (VCSELs), and edge emitting lasers are among the most efficient light sources currently available. Materials systems currently of interest in the manufacture of high-brightness light emitting devices capable of operation across the visible spectrum include Group III-V semiconductors, particularly binary, ternary, and quaternary alloys of gallium, aluminum, indium, and nitrogen, also referred to as III-nitride materials. Typically, III-nitride light emitting devices are fabricated by epitaxially growing a stack of semiconductor layers of different compositions and dopant concentrations on a sapphire, silicon carbide, III-nitride, or other suitable substrate by metal-organic chemical vapor deposition (MOCVD), molecular beam epitaxy (MBE), or other epitaxial techniques. The stack often includes one or more n-type layers doped with, for example, Si, formed over the substrate, one or more light emitting layers in an active region formed over the n-type layer or layers, and one or more p-type layers doped with, for example, Mg, formed over the active region. Electrical contacts are formed on the n- and p-type regions.

III-nitride LEDs are attractive candidates for automotive headlights for several reasons. First, the operational lifetime of LEDs is typically far longer than other light sources such as incandescent light bulbs. In addition, LEDs may be more robust than incandescent bulbs. For example, LEDs may be less likely to fail when exposed to mechanical shocks and temperature variations. Also, headlight assemblies using LEDs for the light source may be more compact in size, and may have more flexibility in form, than headlight assemblies using incandescent bulbs as the light source.

An adaptive lighting system is a system where the beam pattern projected is selectively altered. For example, in an adaptive lighting system for an automotive headlight, the beam pattern projected anticipates the direction of the automobile and selectively alters the beam pattern to produce light in that direction.

US 2004/0263346, which is incorporated herein by reference, describes the solid state adaptive forward lighting system shown in FIG. 1. The system of FIG. 1 includes an array 42 of light emitting diodes (“LEDs”) 43. Each row of the array 42 is electrically connected to a horizontal LED driver 36, and each column of the array 42 is electrically connected to a vertical LED driver 34. The horizontal and vertical drivers 36 and 34 are attached to a central processing unit 28. A wheel angle sensor 20 and an incline sensor 24 are both attached to the central processing unit 28. A converging lens (not shown in FIG. 1) is positioned in front of the array 42. Upon receiving signals from the wheel angle sensor 20 and the incline sensor 24, the central processing unit 28 communicates with the horizontal and vertical LED drivers 36 and 34, to illuminate selected LEDs 43 in the array 42. Light rays from the LEDs 43 are angled by the lens, such that the selective illumination of one or more of the LEDs 43 in the array 42 allows the headlamp to project light in variable horizontal and vertical directions. Horizontal and vertical lines connected to each LED in the array terminate into a horizontal bus 38 and a vertical bus 40, respectively. The horizontal bus 38 is in electrical communication with the horizontal LED driver 36, and the vertical bus 40 is in electrical communication with the vertical LED driver 34. Each of the horizontal lines 60 and vertical lines 62 terminates in an associated switch, which is operable by the horizontal LED driver 36 and the vertical LED driver 34, respectively.

Needed in the art are adaptive lighting systems including III-nitride light emitting devices.

### SUMMARY

It is an object of the invention to provide an adaptive lighting system including III-nitride light emitting devices as the light source.

In embodiments of the invention, a device includes a light source, a sensor, and a controller. The light source includes at least one light emitting device connected to a mount. The light emitting device comprises a plurality of segments with neighboring segments spaced less than 200 microns apart. In some embodiments, the plurality of segments are grown on a single growth substrate. Each segment includes a III-nitride light emitting layer disposed between an n-type region and a p-type region. The mount is configured such that at least two segments may be independently activated. The controller is coupled between the sensor and the mount. The controller is operable to receive an input from the sensor and based on the input, selectively illuminate at least one segment in the light source.

### BRIEF DESCRIPTION OF THE DRAWINGS

FIG. 1 illustrates a prior art adaptive forward lighting system.

FIG. 2 illustrates an adaptive lighting system according to embodiments of the invention.

FIG. 3 is a top view of an array of III-nitride light emitting devices.

FIG. 4 is a simplified side view of a single III-nitride light emitting device divided into segments with the contacts for each segment formed on the same side of each segment.

FIG. 5 is a simplified side view of a single III-nitride light emitting device divided into segments that share a common p- or n-type region.

FIG. 6 is a circuit diagram of the arrangement illustrated in FIG. 5.

FIG. 7 is a simplified side view of a single III-nitride light emitting device divided into segments with the contacts for each segment formed on opposite sides of each segment.

FIG. 8 illustrates a stabilized spotlight according to embodiments of the invention.

### DETAILED DESCRIPTION

Embodiments of the present invention may be used as an adaptive lighting system. The examples below refer to a vehicle headlight and a jitter-stabilized flashlight, though embodiments of the invention may be used for any other suitable application such as marine lighting and spotlighting.

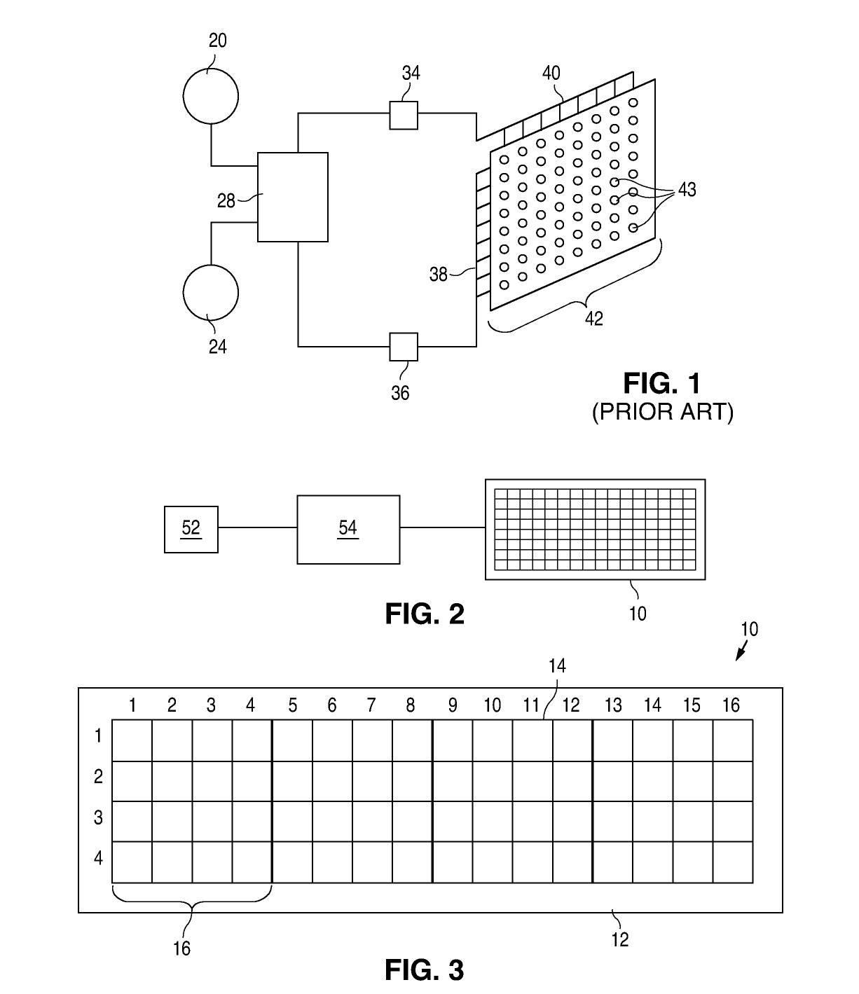

In the system illustrated in FIG. 1, small, low power LEDs may be used. A similar array using individual, currently-available large junction III-nitride LEDs capable of operating at high power may be too large and too expensive, and when all elements are illuminated, would produce far more light than required for safety and by automotive lighting standards.

FIG. 2 illustrates an adaptive lighting system according to embodiments of the invention. A light source 10, which may be an array of III-nitride light emitting devices, each device divided into multiple segments, is connected to a controller 54. Controller 54 receives inputs from one or more sensors 52 and illuminates some or all of the segments in light source 10 in response to the inputs.

FIG. 3 is a top view of a light source 10 according to embodiments of the invention. An array of LEDs 14 is attached to a mount 12. Four LEDs 16 are illustrated. Each LED 16 is divided into multiple segments. Each LED illustrated in FIG. 3 is divided into a 4×4 array of segments, for a total of 16 segments per LED and 64 segments total. For example, each LED 16 may be about 1 mm by 1 mm in area, and each segment may be about 250 microns by 250 microns. The LEDs and segments need not be square as illustrated in FIG. 3; they may be rectangular, parallelogram, rhomboid, or any combination of shapes. More or fewer than four LEDs may be used, and each LED may be divided into more or fewer than 16 segments. In addition, the LEDs need not be symmetrical. For example, some LEDs may be divided into fewer and/or larger segments. For example, some or all of the LEDs may be divided into 1×2, 2×2, 2×3, 2×5, 3×6, or 5×6 segments. In some embodiments, light source 10 may include between 30 and 100 segments. The size of each segment is selected to match the desired total area of the LED, and the total number of desired elements. In some embodiments, the total required area for an LED headlamp is between 4 and 24 mm². Accordingly, segment size may range from 1 to 0.5 mm² down to 0.04 mm².

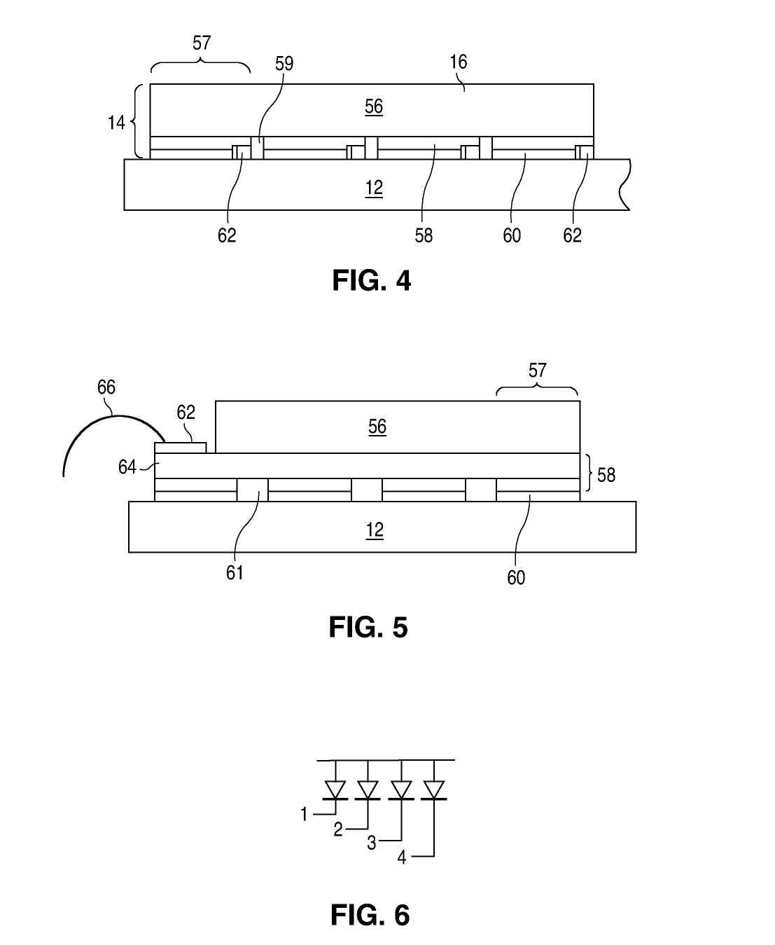

FIG. 4 is a simplified side view of a single LED 16 divided into segments 57. Four segments 57 are illustrated in FIG. 4. The LED is represented by number 14 in FIG. 4, and a portion of mount 12 is illustrated. Though FIG. 4 illustrates a thin film flip chip device, other types of devices may be used, such as vertical devices, where the n- and p-contacts are formed on opposite sides of the device, devices with the n- and p-contacts both formed on the side of the semiconductor structure opposite mount 12, or a flip chip device in which the growth substrate remains a part of the device.

Each LED segment 57 includes semiconductor layers 58, which include an n-type region, a light emitting or active region, and a p-type region. Semiconductor layers 58 may be grown on a growth substrate such as, for example, sapphire, SiC, GaN, Si, one of the strain-reducing templates grown over a growth substrate such as sapphire described in US 2008/0153192, which is incorporated herein by reference, or a composite substrate such as, for example, an InGaN seed layer bonded to a sapphire host, as described in US 2007/0072324, which is incorporated herein by reference.

The n-type region is typically grown first and may include multiple layers of different compositions and dopant concentration including, for example, preparation layers such as buffer layers or nucleation layers, which may be n-type or not intentionally doped, release layers designed to facilitate later release of the growth substrate or thinning of the semiconductor structure after substrate removal, and n- or even p-type device layers designed for particular optical or electrical properties desirable for the light emitting region to efficiently emit light. A light emitting or active region is grown over the n-type region. Examples of suitable light emitting regions include a single thick or thin light emitting layer, or a multiple quantum well light emitting region including multiple thin or thick quantum well light emitting layers separated by barrier layers. A p-type region is grown over the light emitting region. Like the n-type region, the p-type region may include multiple layers of different composition, thickness, and dopant concentration, including layers that are not intentionally doped, or n-type layers.

A p-contact 60 is formed on the top surface of p-type region. P-contact 60 may include a reflective layer, such as silver. P-contact 60 may include other optional layers, such as an ohmic contact layer and a guard sheet including, for example, titanium and/or tungsten. On each segment 57, a portion of p-contact 60, the p-type region, and the active region is removed to expose a portion of the n-type region on which an n-contact 62 is formed. U.S. application Ser. No. 12/236,853, which is incorporated herein by reference, describes forming contacts on an LED divided into segments grown on the seed layer of a composite substrate formed in islands.

Trenches 59, which may extend through an entire thickness of the semiconductor material, are formed between each segment 57 to electrically isolate adjacent segments. Trenches 59 may be filled with a dielectric material such as an oxide of silicon or a nitride of silicon formed by plasma enhanced chemical vapor deposition, for example. Other methods of electrical isolation besides trenches, such as non-conductive III-nitride material, may be used.

Interconnects (not shown in FIG. 4) are formed on the p- and n-contacts, then the device is connected to mount 12 through the interconnects. The interconnects may be any suitable material, such as solder, gold, Au/Sn, or other metals, and may include multiple layers of materials. In some embodiments, interconnects include at least one gold layer and the bond between the LED segments and the mount is formed by ultrasonic bonding. During ultrasonic bonding, the LED die is positioned on a mount. A bond head is positioned on the top surface of the LED die, for example on the top surface of the growth substrate. The bond head is connected to an ultrasonic transducer. The ultrasonic transducer may be, for example, a stack of lead zirconate titanate (PZT) layers. When a voltage is applied to the transducer at a frequency that causes the system to resonate harmonically (often a frequency on the order of tens or hundreds of kHz), the transducer begins to vibrate, which in turn causes the bond head and the LED die to vibrate, often at an amplitude on the order of microns. The vibration causes atoms in the metal lattice of a structure on the LED, such as the n- and p-contacts or interconnects formed on the n- and p-contacts, to interdiffuse with a structure on the mount, resulting in a metallurgically continuous joint. Heat and/or pressure may be added during bonding.

After the semiconductor structure is bonded to mount 12, all or part of the growth substrate may be removed. For example, a sapphire growth substrate or a sapphire host substrate that is part of a composite substrate may be removed by laser melting of a III-nitride or other layer at an interface with the sapphire substrate. Other techniques such as etching or mechanical techniques such as grinding may be used as appropriate to the substrate being removed. After the growth substrate is removed, the semiconductor structure may be thinned, for example by photoelectrochemical (PEC) etching. The exposed surface of the n-type region may be textured, for example by roughening or by forming a photonic crystal.

One or more wavelength converting materials 56 may be disposed over the semiconductor structure. The wavelength converting material(s) may be, for example, one or more powder phosphors disposed in a transparent material such as silicone or epoxy and deposited on the LED by screen printing or stenciling, one or more powder phosphors formed by electrophoretic deposition, or one or more ceramic phosphors glued or bonded to the LED, one or more dyes, or any combination of the above-described wavelength converting layers. Ceramic phosphors, also referred to as luminescent ceramics, are described in more detail in U.S. Pat. No. 7,361,938, which is incorporated herein by reference. The wavelength converting materials may be formed such that a portion of light emitted by the light emitting region is unconverted by the wavelength converting material. In some examples, the unconverted light is blue and the converted light is yellow, green, and/or red, such that the combination of unconverted and converted light emitted from the device appears white.

In some embodiments, one or more lenses, polarizers, dichroic filters or other optics known in the art are formed over the wavelength converting layer 56 or between wavelength converting layer 56 and semiconductor structures 58, over some or all of the segments in array 14.

FIG. 5 illustrates an alternative embodiment of a single LED divided into segments 57. Trenches 61 between individual segments 57 extend only through the active region of semiconductor layer 58. The four segments shown share a common n-type region 64. A single n-contact 62 formed on the common n-type region may be wire-bonded 66 or otherwise electrically connected to mount 12. In some embodiments, the n- and p-type regions may be reversed such that the four segments illustrated share a common p-type region. The common re-contact 62 may be always biased, such that whether a segment is on or off is determined by the p-contact 60 connection to mount 12, as illustrated in the circuit diagram shown in FIG. 6.

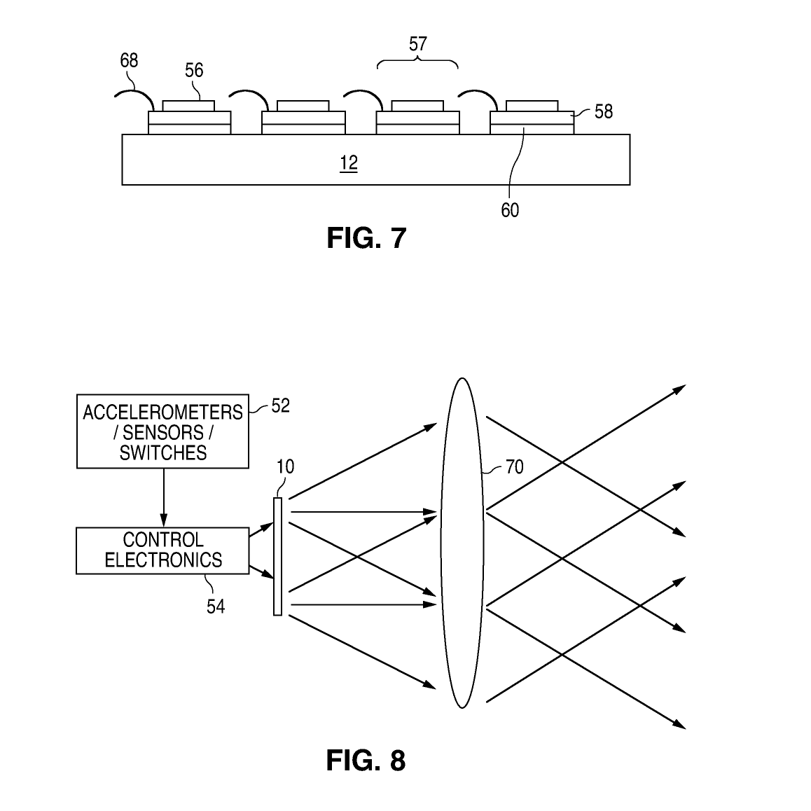

FIG. 7 illustrates an alternative embodiment of a single LED divided into segments 57. P-contacts 60 connect each segment to mount 12. The growth substrate is removed to expose the n-type region, on which individual n-contacts are formed which may be wire-bonded 68 or otherwise electrically connected to mount 12. Individual wavelength converting elements 56 may be formed over each segment 57.

FIGS. 4, 5, and 7 describe LEDs divided into segments. Each LED is grown on a single growth substrate. In some embodiments, neighboring segments are closely spaced on a single mount but need not be grown on the same substrate. For example, neighboring segments may be spaced less than 200 microns apart in some embodiments, less than 100 microns apart in some embodiments, less than 50 microns apart in some embodiments, less than 25 microns apart in some embodiments, less than 10 microns apart in some embodiments, and less than 5 microns apart in some embodiments.

Mount 12 is formed such that at least some of segments 57 can be independently activated. For example, mount 12 may be a ceramic or silicon substrate with metal traces and optional circuit elements such as Zener diodes, transistors, detectors, controllers, and other active and/or passive elements, formed by conventional processing steps. Some segments may always be activated together, and may be connected for example in series or in parallel. In some embodiments, at least two segments can be independently activated. In some embodiments, all segments can be independently activated. Interconnects connecting such segments may be formed on or within mount 12 or on the LED array 14, as described, for example, in U.S. Pat. No. 6,547,249, which is incorporated herein by reference.

Based on inputs from sensors 52, controller 54 activates some or all of segments 57 on light source 10. Controller 54 may be any suitable controller such as, for example, an electronic or computer controller as is known in the art, or software associated with a central processing unit as is known in the art, or any other kind of circuit capable of receiving input signals from sensors 52 and generating output signals to activate some or all of segments 57 by applying electrical signals to appropriate connections on mount 12. The controller 54 and sensors 52 may be separate from mount 12 or may be fully or partially incorporated into mount 12.

One or more sensors 52 may provide inputs to controller 54. Sensors 52 may include, for example, user inputs such as a high/low beam selector switch, an incline sensor such as accelerometer that senses the position of the light source relative to gravity, a wheel position sensor that senses when the wheels are turned to the left or right, and a machine vision system that senses, for example, objects on the ground around an automobile.

In operation, one or more sensors 52 provides an input to controller 54, which then activates some or all of segments 57. For example, when the driver selects low beams on a high/low beam selector switch, controller 54 may activate, for example, only the segments located in rows 3 and 4 or 2, 3, and 4 and in columns 1-16 or 3-14. When the driver selects high beams on a high/low beam selector switch, controller 54 may activate all segments, and/or may provide higher current to some or all segments, such that those segments activated at higher current produce more light. Even during normal operation, such as when the low beams are selected on flat terrain, controller 54 may supply higher current to some segments, for example at the center of array 14, to provide light far ahead of the vehicle, and lower current to some segments, for example at the edges of array 14, to provide lower light in a region immediately in front of the vehicle. Alternatively or in addition to driving different segments at different currents, lenses or other optics may be shaped to provide light at the center far away, and to light the entire front region of the vehicle for a short distance.

When an accelerometer indicates that the vehicle is tilted, such as when the vehicle is pointed up a hill or when the rear of a vehicle is heavily loaded, controller 54 may activate segments in the lower part of array 14, for example the segments located in rows 3 and 4 or 2, 3, and 4 and in columns 1-16.

When a wheel position sensor indicates that the vehicle is turning left or right, the controller 54 may activate additional segments on the right or left side of array 14, for example the segments in rows 1-4 and in columns 1-4 or 13-16, depending on whether the vehicle is turning left or right. These segments may be lighted in addition to segments in rows 2-4 and in columns 5-12, which are activated for low beam operation.

When a machine vision system indicates that there is an object in front of the vehicle, the controller 54 may active segments which are aligned with the object, in order to light the object.

Controller 54 may be configured to respond to a single sensor or multiple sensors at once, such as activating segments corresponding to high beams while turning left, and so forth.

In some embodiments, controller may 54 be configured to activate different beam patterns, where the standard beam varies according to driving environment. For example, different standard beams may be activated for motorway, country, urban, and high beam driving situations. Other capabilities include automated high beam/low beam switching, “marker light” illumination (i.e. highlighting a specific object), and glare prevention for oncoming traffic (vehicular or otherwise). In some embodiments, one sensor is a user-activated or automatically-activated switch that controls every segment identically.

FIG. 8 illustrates an adaptive lighting system for spotlighting. A collimating lens 70, which translates position of light into angle of light as illustrated in FIG. 8, receives light from a light source 10, such as one including multiple LED segments as described above. The use of a segmented LED allows collimating lens 70 to be compact. For example, individual, non-segmented LEDs may each have a diameter between 1.5 mm and 5 mm. An array of 64 such LEDs may be between 12×12 mm and 40×40 mm. A lens needed to project a beam from such a source may need a diameter between 50 mm and 200 mm. In contrast, a 2×2 mm LED divided into 64 segments may need a lens no more than 35 mm in diameter, which may significantly reduce the size and cost of the system.

One application of the system illustrated in FIG. 8 is a jitter-stabilized flashlight. Controller 54 compensates for hand-held jitter by selectively activating segments in light source 10, in response to input from sensors 52, which may be, for example, accelerometers, sensors, or switches that detect how the light source is moving. Controllers for electronic image stabilization are well known in the field of video recorders. Such a controller may be used to stabilize the light beam in a jitter-stabilized spotlight or flashlight.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is being claimed is:

1. A device comprising:
a light source comprising at least one light emitting device connected to a mount, the light emitting device comprising a plurality of segments, each segment comprising a III-nitride light emitting layer disposed between an n-type region and a p-type region, wherein neighboring segments are spaced less than 200 microns apart, wherein the mount is configured such that at least two segments may be independently activated;
a sensor; and
a controller coupled between the sensor and the mount, wherein the controller is operable to receive an input from the sensor and based on the input, selectively energize at least one segment in the light source.

2. The device of claim 1 wherein the plurality of segments are grown on a single growth substrate.

3. The device of claim 2 wherein adjacent segments are separated by a trench.

4. The device of claim 3 wherein the trench is filled with a dielectric.

5. The device of claim 2 wherein the growth substrate is removed from each light emitting device.

6. The device of claim 2 wherein at least two neighboring segments share a single n-type region.

7. The device of claim 1 further comprising a wavelength converting material disposed over at least one light emitting device in the light source.

8. The device of claim 1 wherein the sensor comprises a user-activated switch.

9. The device of claim 1 wherein the sensor is operable to indicate an orientation of the light source relative to gravity.

10. The device of claim 1 wherein the sensor is operable to indicate whether a wheel on an automobile is turned.

11. The device of claim 1 wherein the sensor comprises a machine vision system.

12. The device of claim 1 wherein the sensor comprises a switch that is user-activated or automatically-activated, wherein the switch controls every segment identically.
